(19) United States
(12) Patent Application Publication
(10) Pub. No.: US 2015/0254680 A1
(43) Pub. Date: Sep. 10, 2015

(54) UTILIZING PRODUCT AND SERVICE REVIEWS

(71) Applicant: Pascal Scoles, Collegeville, PA (US)

(72) Inventor: Pascal Scoles, Collegeville, PA (US)

(21) Appl. No.: 14/586,846

(22) Filed: Dec. 30, 2014

Related U.S. Application Data
(60) Provisional application No. 61/948,177, filed on Mar. 5, 2014.

(51) Int. Cl. G06Q 30/02; G06Q 30/00; G06F 17/30

(52) U.S. Cl. CPC G06Q 30/0201; G06F 17/30876; G06Q 30/0282; G06Q 30/0185

(57) ABSTRACT

Methods, systems, and apparatus for processing item reviews are described. An item review is obtained. Content of the item review and a reviewer of the item review are analyzed. A review weighting based on the analysis of the content of the item review and the reviewer of the item is determined.

### CLAIM OF PRIORITY

This application claims the benefit of priority to U.S. Provisional Patent Application Ser. No. 61,948,177, filed on Mar. 5, 2014, which is incorporated by reference herein in its entirety.

### TECHNICAL FIELD

The present application relates generally to electronic commerce and, more specifically, in one example, to utilizing product and service reviews.

### BACKGROUND

Consumers are shopping online for a growing variety of products and services and may conduct searches to locate items that are available for purchase or to access information regarding the items. Consumers of products and services may generally include retail consumers, distributors, small business owners, business representatives, corporate representatives, non-profit organizations, and the like. The providers of the products and/or services may include individuals, retailers, wholesalers, distributors, manufacturers, service providers, small business owners, independent dealers, and the like. A listing for an item that is available for purchase may include a price, a description of the product and/or service, and, optionally, a picture of the item and one or more specific terms for the offer.

A review of the item may be retrieved from various web-based sources, such as technical websites, product review websites, electronic commerce websites, blogs, forums, and the like. In addition, the listing for an item may include one or more reviews of the item. The cited reviews may be aggregated into an overall score or rating for the item. The reviews may be primarily submitted by users of the product or service. In some cases, reviews may be submitted by marketing firms, public relations firms, a competitor of the product or service, an unreliable user, and the like, and may constitute an unreliable source of review information.

In some cases, a review may be erroneously categorized as a review for a product or service when the review is actually a review of the seller of the item, the customer service provided by the company that makes the product, the shipping company that delivered the item, and the like. Thus, reviews associated with an item may be inaccurate and/or irrelevant.

### BRIEF DESCRIPTION OF THE DRAWINGS

Some embodiments are illustrated by way of example and not limitation in the figures of the accompanying drawings in which:

FIG. 1 is a block diagram of an example electronic commerce system for searching for products and/or services and for obtaining reviews of products and/or services, in accordance with an example embodiment;

FIG. 2 is a flowchart for an example electronic commerce method for listing, indexing, and searching for a product and/or service, in accordance with an example embodiment;

FIG. 3 is a block diagram of an example apparatus for obtaining and utilizing reviews of products and/or services, in accordance with an example embodiment;

FIG. 4 is a representation of an example user interface for performing a search for a product and/or service and for obtaining reviews of products and/or services, in accordance with an example embodiment;

FIG. 5 is a representation of an example user interface for displaying a review of a product and/or service, in accordance with an example embodiment;

FIG. 6 is a flowchart for an example user interface method, in accordance with an example embodiment;

FIGS. 7A-7D illustrate a flowchart for an example method for validating reviews of products and/or services, in accordance with an example embodiment;

FIG. 8 is a table of example rules for validating reviews of products and/or services, in accordance with an example embodiment;

FIG. 9 is a block diagram of an example apparatus for performing a search for products and/or services, in accordance with an example embodiment;

FIG. 10 is a block diagram illustrating a mobile device, according to an example embodiment; and

FIG. 11 is a block diagram of a machine within which instructions may be executed for causing the machine to perform any one or more of the methodologies discussed herein.

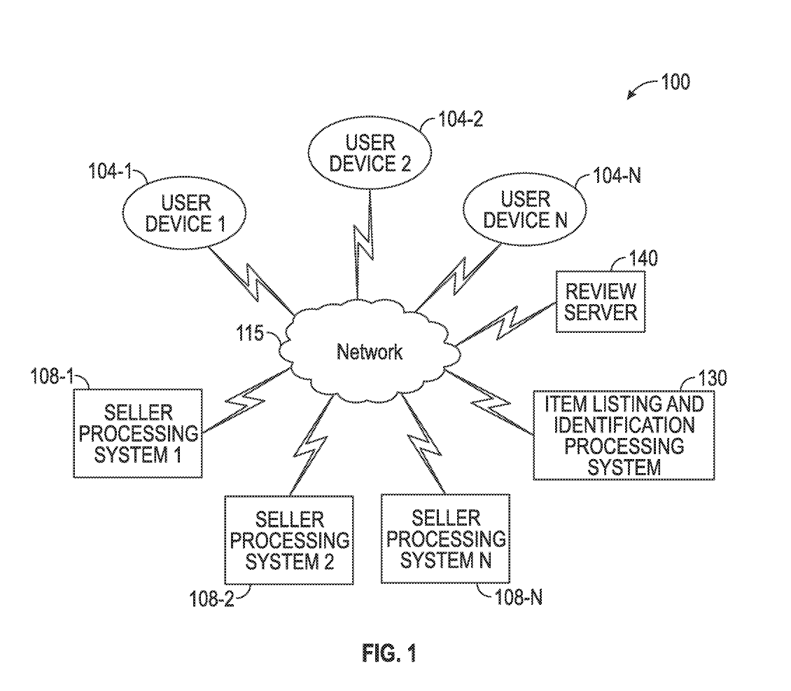

### DETAILED DESCRIPTION

ho the following detailed description of example embodiments, reference is made to specific examples by way of drawings and illustrations. These examples are described in sufficient detail to enable those skilled in the art to practice these example embodiments, and serve to illustrate how the invention may be applied to various purposes or embodiments. Other embodiments of the invention exist and are within the scope of the invention, and logical, mechanical, electrical, and other changes may be made without departing from the scope or extent of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

Generally, methods, systems, and apparatus for utilizing product and/or service reviews are described. In one example embodiment, a review may be validated as originating from a reliable source and/or pertaining to the specified product or service. In one example embodiment, a review may be weighted according to an estimated reliability of the source of the review and/or relevance of the review. In one example embodiment, reviews that are fraudulent, not directly pertaining to the item, and the like are filtered. The filtering may either discard the review, mark the review as being unreliable and/or irrelevant, or appropriately weight the review. In one example embodiment, a browser plugin may be used to perform the filtering operation.

In one example embodiment, a consumer may conduct a search for a review of an item (e.g., an item available for sale). As used herein, an “item” may refer to a product, a service, a combination of a product and a service, and the like. The item review may be a component of an item listing provided by an electronic commerce service or may be separate from an item listing.

In one example embodiment, a consumer may conduct a search for an item, and the search result set may produce a list of available items of varying degrees of relevance. The consumer may select one or more items in the search result set that may be of interest to the consumer and on which the consumer may desire to receive additional information and/or execute a transaction. The search results may include one or more reviews of the selected item(s).

in one example embodiment, natural language processing is used to detect fraudulent, unreliable, and/or irrelevant reviews. In one example embodiment, reviews are correlated to usernames or other user identities to assist in the filtering process. In one example embodiment, a set of one or more rules may be defined for calculating a confidence rating of a reviewer, calculating a confidence rating of an item review, calculating a review score for an item, calculating an overall review score for an item, calculating an overall confidence rating for the cited overall score, and the like. The set of rules may be a default set of rules or may be defined by a user. The user may utilize existing rules and/or modify one or more rules or sets of rules. Each rule may be defined for a particular item, for a set of items, for a particular user, and/or for a particular set of users.

In one example embodiment, one or more of the following techniques are utilized in filtering reviews: 1) natural language processing of reviews to compare a review style of a selected review to a style of one or more known unreliable reviews or unreliable reviewers (such as reviews submitted by unreliable reviewers or non-human entities, e.g., computer-generated reviews); 2) natural language processing to determine whether the review is directed to the product itself; 3) verifying that a reviewer is a user or purchaser of the item (if relevant information is available); 4) determining a reviewer's rating (may be based on, for example, a count of submitted reviews); 5) determining if a selected review has been flagged by a user as being helpful or unhelpful; and 6) performing statistical analysis of the ratings specified in a review(s) by a selected reviewer to determine a reliability of the review and/or reviewer. For example, a reviewer may be flagged as submitting an excessive percentage of high and/or low reviews and/or having a suspicious distribution of reviews (e.g., 50% of the reviews are rated one and 50% of the reviews are rated two on a scale of one to ten). The cited techniques may be specified in one or more of the rules cited above.

In one example embodiment, a user may be linked to reviews of reviewers who demonstrate a synergy with the user. For example, reviewers who have submitted reviews that are similar to the reviews submitted by the user, who have a similar set of hobbies or set of interests as the user, who have a similar mindset as the user, who are friends with the user, who are known to be trusted by the user, and the like may be identified. The reviews of the identified reviewers may be selected and/or weighted more highly for the particular user. In one example embodiment, a user may identify a reviewer as being a trusted reviewer. For example, if a user reads one or more reviews of a reviewer and likes the reviews, the user may decide to mark the reviewer as a trusted reviewer.

FIG. I is a block diagram of an example electronic commerce system 100 for searching for products and/or services and/or for accessing and utilizing product and/or service reviews, in accordance with an example embodiment. In one example embodiment, the system 100 may include one or more user devices 104-1, 104-2, and 104-N (known as user devices 104 hereinafter), one or more optional seller processing systems 108-1, 108-2, and 108-N (known as seller processing systems 108 hereinafter), an item listing and identification processing system 130, a review server 140, and a network 115. Each user device (e.g., 104-1) may be a personal computer (PC), a tablet computer, a mobile phone, a personal digital assistant (PDA), a wearable computing device (e.g., a smartwatch), or any other appropriate computer device. Each user device (104-1, 104-2, or 104-N) may include a user interface module, described more fully below in conjunction with FIG. 3. In one embodiment, the user interface module may include a web browser program and/or an application, such as a mobile application. Although a detailed description is only illustrated for user device 104-1, it is noted that each of the other user devices (e.g., user device 104-2 through user device 104-N) may have corresponding elements with the same functionality.

The optional seller processing systems 108, the item listing and identification processing system 130, and the review server 140 may be a server, client, or other processing device that includes an operating system for executing software instructions. The optional seller processing systems 108 may provide items for sale to a consumer, and may facilitate the search for and purchase of the items to a variety of consumers. The review server 140 may be a component of the item listing and identification processing system 130 or may be separate from the item listing and identification processing system 130.

The network 115 may be may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, a network of interconnected networks, or a combination of two or more such networks, and the like.

Each user device 104 may receive a query for item information from a user via an input device such as keyboard, touchscreen, microphone, mouse, electronic pen, and the like. An item may include, for example, a product and/or a service, and the corresponding information may be in the form of an item listing.

The item listing and identification processing system 130 of an online listing system may store and/or obtain information related to items available for sale. Each item listing may include a detailed description of the item, a picture of the item, attributes of the item, one or more reviews of the item, and the like. The item associated with the item listing may be a good or product (e.g., a tablet computer) and/or service (e.g., a round of golf or appliance repair) that may be transacted (e.g., exchanging, sharing information about, buying, selling, making a bid on, and the like). The item listing may also include a title, a category (e.g., electronics, sporting goods, books, antiques, and the like), and attributes and tag information (e.g., color, size, and the like).

The review server 140 may provide access to reviews of products and/or services. For example, the review server 140 may provide a product review in response to a search for information on the product.

Referring back to the user device 104-1, the query received from the user of user device 104-1 may include one or more keywords, The user device 104-1 may transmit the query to the item listing and identification processing system 130 via the network 115. The item listing and identification processing system 130 may attempt to match the query keywords with the title, the category, the tag information, and/or any other field in the item listing using a search engine.

In response to the submission of the search query, the item listing and identification processing system 130 may attempt to identify one or more item listings that satisfy the query. The item listing and identification processing system 130 may retrieve and then sort the item listings in the search result in a known manner. The item listing and identification processing system 130 may then return a sorted search result list to the user device 104-1 that submitted the query. The consumer may select one or more items in order to obtain additional information on the item and/or purchase the item. For example, the consumer may obtain one or more reviews on the item and/or an overall score based on a plurality of reviews.

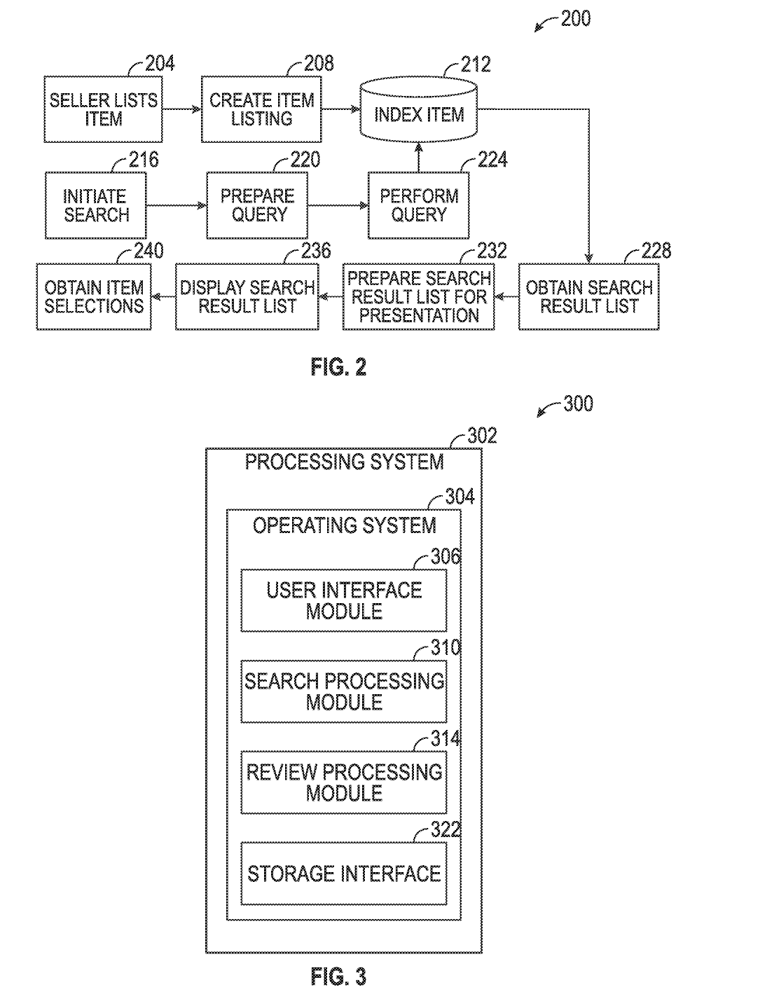

FIG. 2 is a flowchart for an example electronic commerce method 200 for listing, indexing, and searching for a product and/or service, in accordance with an example embodiment. In one example embodiment, a seller may list an item for sale (operation 204). The seller may, for example, select a category for the item, submit a description of the item, submit a picture of the item, manually set attributes of the item, and the like.

An item listing may be created, for example, in an item listing database (operation 208). The listing may include, for example, attributes of the item and terms of the sale offer. During the item listing operation 208, an identification number for the item listing may be assigned, and the listing may be authenticated and scanned to check for conformance with one or more listing policies. The listed item may be indexed (operation 212) in a known manner to facilitate future searches for the item,

A consumer may initiate a search or query for one or more items (operation 216). For example, a consumer may initiate a search using the keywords “golf clubs,” A corresponding query may be prepared (operation 220). For example, a spell check may be performed on the query terms, and a search expression may be generated based on the provided search terms.

The query may be executed on, for example, the items that have been indexed in the system (operation 224), For example, the prepared query may be matched against the index that was updated during operation 212.

In response to the execution of the query, a search result list may be obtained (operation 228). The search result list may be prepared for presentation (operation 232). For example, the search result list may be filtered, sorted, ranked, and/or formatted based, for example, on an analysis of the search result list

The prepared search result list may be displayed (operation 236). In response to reviewing the displayed search result list, one or more item selections from one or more displayed item pages may be obtained from a user (operation 240).

FIG. 3 is a block diagram of an example apparatus for utilizing product and/or service reviews, in accordance with an example embodiment. The apparatus 300 is shown to include a processing system 302 that may be implemented on a client or other processing device that includes an operating system 304 for executing software instructions. The apparatus 300 may he implemented as the review server 140.

In accordance with an example embodiment, the apparatus 300 may include a user interface module 306, a search processing module 310, and a review processing module 314. In accordance with an example embodiment, the apparatus 300 may further include a storage interface 322.

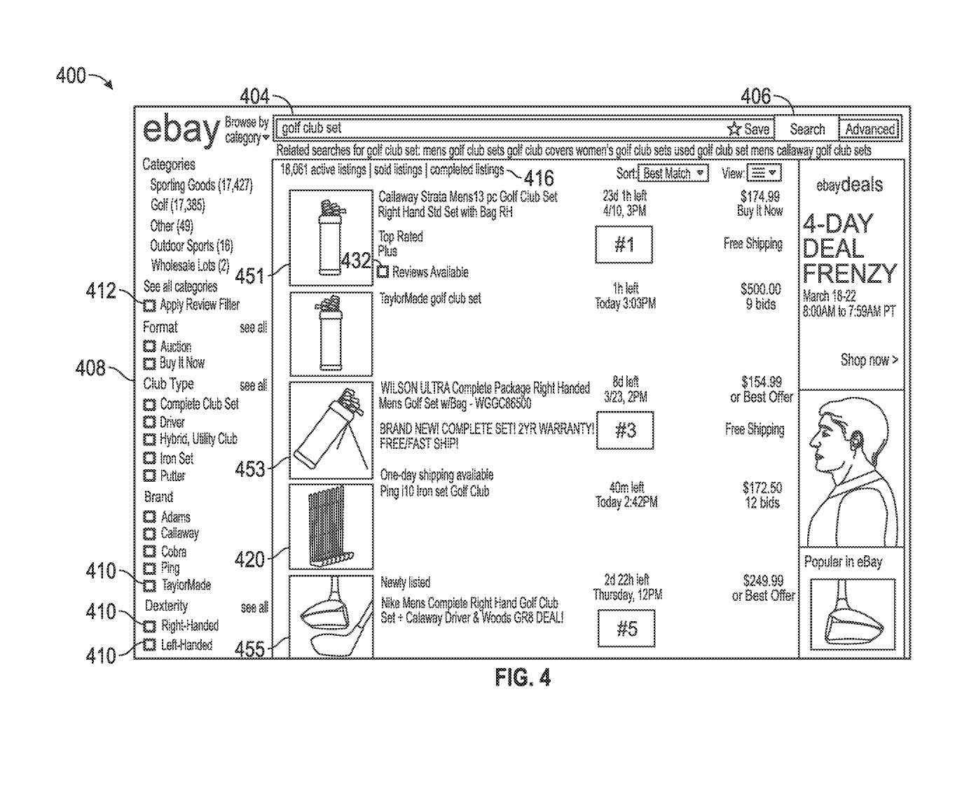

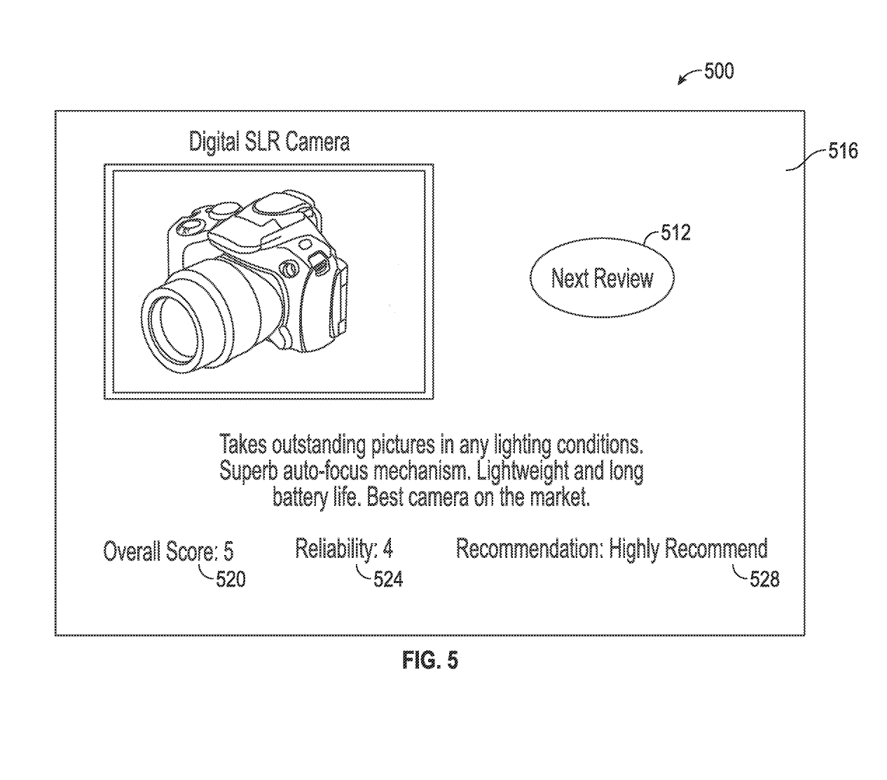

The user interface module 306 may obtain search criteria from a user (e.g., a consumer), may present a search result list to a user, may obtain item selections from a user, may present an item listing to a user, may present an item review to a user, and may allow a user to submit and/or modify a set of rules for filtering item reviews. The user interface module 306 may provide user interface 400 and user interface 500, as described more fully below in conjunction with FIGS. 4 and 5, respectively.

The search processing module 310 may submit a query to the item listing and identification processing system 130 and may obtain a search result list from the item listing and identification processing system 130. The search processing module 310 may submit a search for an item review and may obtain the reviews identified in the review search result list. The reviews may be retrieved from various web-based sources, such as technical websites, product review websites, electronic commerce websites, blogs, forums, and the like.

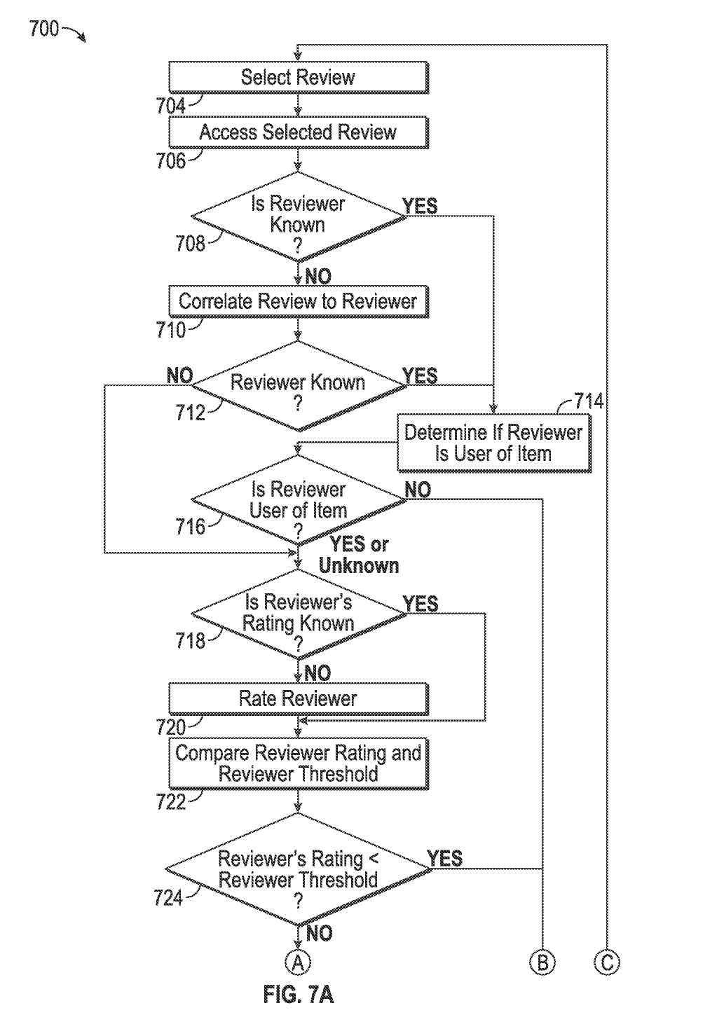

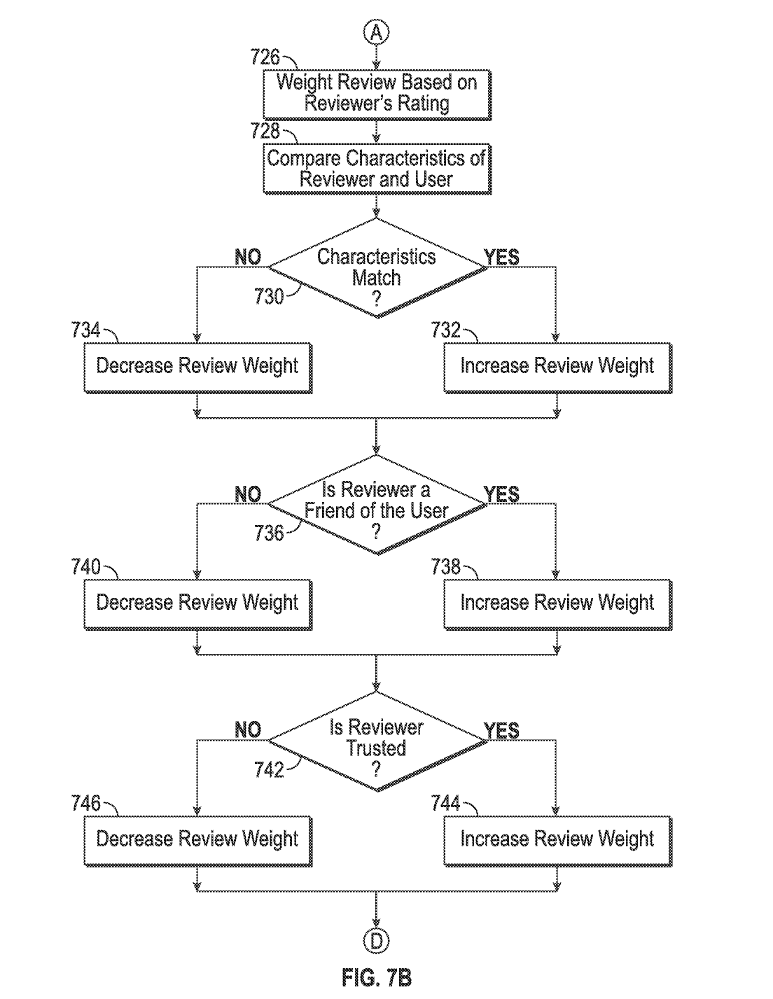

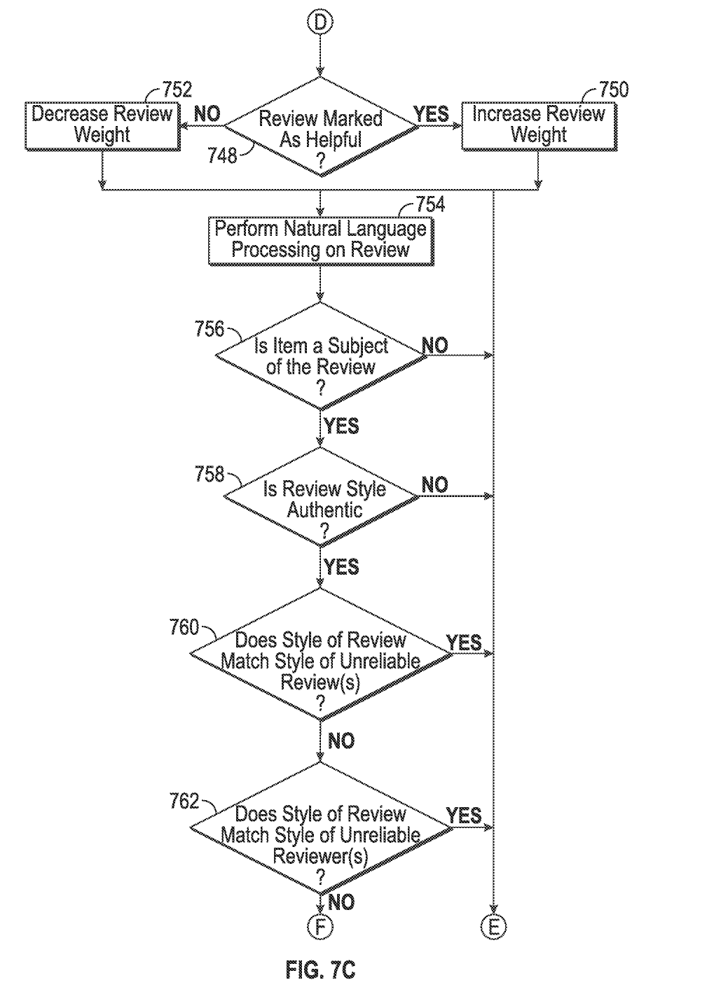

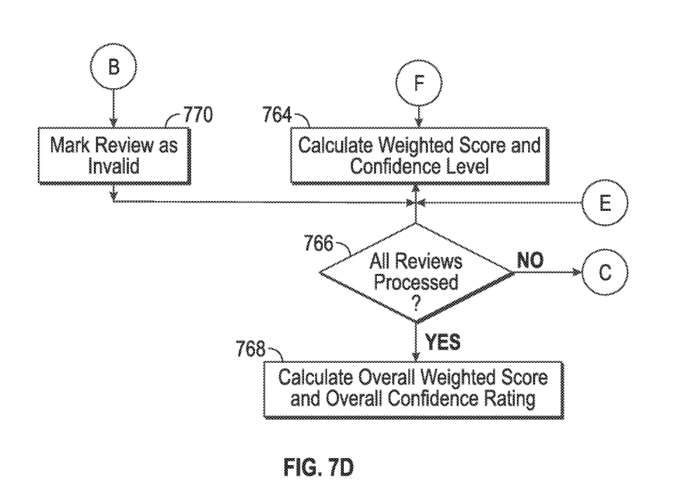

The review processing module 314 may validate an item review, validate an item reviewer, weight a review based on an analysis of the review and/or reviewer, determine if a reviewer has synergy with a user, and the like, as described more fully herein. In one example embodiment, the review processing module 314 may maintain one or more sets of rules for analyzing reviews and/or reviewers, and may utilize natural language processing and/or statistical analysis in the review process. The review processing module 314 may perform a method for utilizing and filtering item reviews, as described more fully below in conjunction with FIG. 7.

FIG. 4 is a representation of an example user interface 400 for performing a search for a product and/or service and for obtaining reviews of products and/or services, in accordance with an example embodiment. In one example embodiment, the user interface 400 may be utilized by the user device 104-1 to enable a user to conduct a search for an item and/or to access an item review.

In one example embodiment, one or more keywords may be entered in an input search field 404, and a search button 406 may be selected to initiate the search. The search may be constrained by the search filter settings identified by filter selection indicators 410 in a filter selection area 408. One or more items 420 may be displayed in a search result list area 416. In the example user interface 400, the items in input search field 404 are a variety of sets of golf clubs. Golf sets 451, 453, 455 are right-handed golf sets.

in one example embodiment, an “apply review filter” radio button 412 enables a user to activate or deactivate the review filter(s), as described herein. In one example embodiment, a “reviews available” radio button 432 will appear with the item listing if reviews are available for the corresponding item. The “reviews available” radio button 432 may be selected to access one or more of the reviews, as described more fully below in conjunction with FIG. 5.

FIG. 5 is a representation of an example user interface 500 for displaying an example review of a product and/or service, in accordance with an example embodiment. In one example embodiment, the user interface 500 may be utilized by a user of user device 104-1 to access an item review.

In one example embodiment, the user interface 500 may be a pop-up window and may display an item review. The item review may comprise text-based comments 516 and one or more values, e.g., an overall score 520, a reliability level 524, and a recommendation level 528. For example, an item review for a digital camera may include comments 516, such as “Takes outstanding pictures in any lighting condition. Superb auto-focus mechanism. Lightweight and long battery life. Best camera on the market” The review may include the recommendation level 528, such as highly recommend, recommend, do not recommend or any other type of scale (e.g., number of stars, numerical rating, and so forth). The review may include the reliability level 524 (for example, a number between one and five, where five represents “highly reliable” and one represents “unreliable”). In addition, the review may include the overall score 520, such as a number between one and five, where five represents “outstanding” and one represents “poor.” In one example embodiment, a user may access another review for the item by selecting the next review radio button 512.

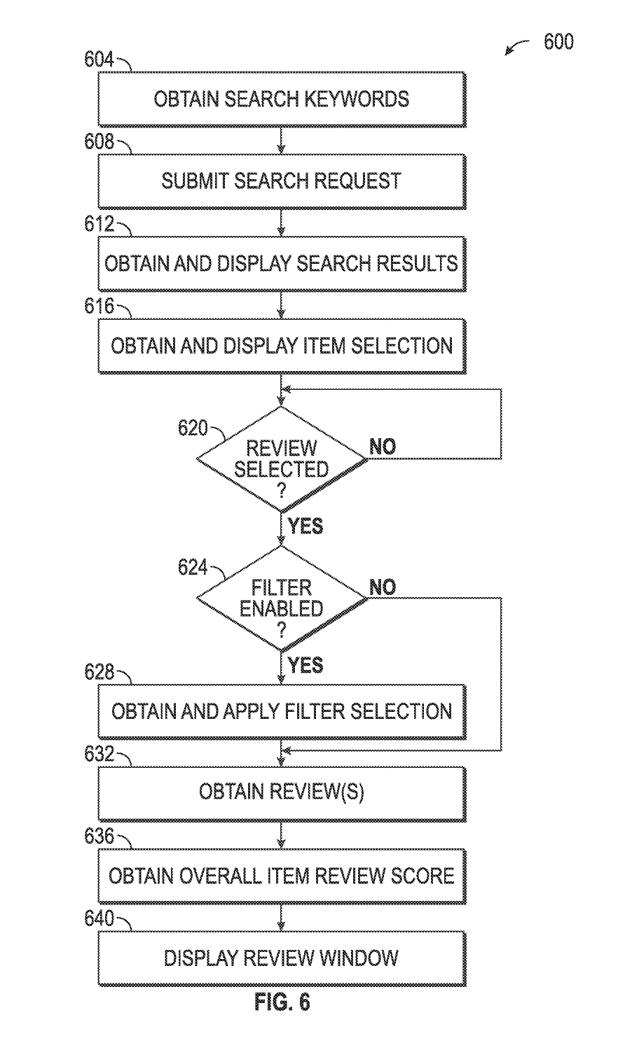

FIG. 6 is a flowchart for an example user interface method 600, in accordance with an example embodiment. In one example embodiment, one or more of the operations of the user interface method 600 may be performed by the user device 104-1.

In one example embodiment, one or more keywords may be obtained from a user initiating a search for a product and/or service via the input search field 404 (operation 604). The search may be submitted (operation 608), and a search result list may he obtained and displayed in the search result list area 416 (operation 612). One or more item selections from the search result list area 416 may be obtained from a user and displayed (operation 616). If reviews for one or more of the items are available, the user may select the “reviews available” radio button 432. A test may be performed to determine if a review has been selected (operation 620). If a selection of the “apply review filter” radio button 412 is detected, a test may be performed to determine if the review filter is enabled (operation 624); otherwise, the method 600 proceeds with operation 620. If the review filter is enabled, the filter selection may be obtained and applied by executing the method of FIG. 7 (operation 628); otherwise, the filter selection operation (i.e., operation 628) is bypassed and all reviews may be accessed by the user. A list of reviews may be obtained (operation 632), and an overall item review score may be obtained (operation 636). In response, the user interface 500 may be activated to display the review window (operation 640).

In one example embodiment, the user interface 500 may display a list of all reviews and the user may activate a selected filtering method, if desired. The selected filtering method may be obtained and applied. In one example embodiment, the user interface 500 may automatically apply a default filtering method prior to displaying the list of reviews. An overall item review score may be computed and displayed, as described below in conjunction with FIGS. 7A-7D.

FIGS. 7A-7D illustrate a flowchart for an example method 700 for validating reviews of products and/or services, in accordance with an example embodiment. In one example embodiment, one or more of the operations of the method 700 may be performed by the item listing and identification processing system 130, the review server 140, and/or the user devices 104.

In one example embodiment, a review for an item is selected (operation 704). For example, a review may be selected from a set of reviews that were provided in response to a search for information on a corresponding item. The selected review may be obtained for analysis and, optionally, the weighting of the review and the confidence rating of the review is set to one (operation 706).

A test is performed to determine if an identity of the reviewer is known (operation 708). For example, the review itself may identify the reviewer and a database of known reviewers may be searched based on the reviewer's identity. If the identity of the reviewer is known, the method 700 proceeds with operation 714; otherwise, an attempt to correlate the review with an identity of a reviewer may be performed (operation 710). For example, natural language processing may be performed to identify other reviews and/or other reviewers that use a similar review style and/or language. If a matching review with a known reviewer is found or a matching reviewer is found, the unknown reviewer is identified as the matching reviewer.

A test is performed to determine if an identity of the reviewer was determined during operation 710 (operation 712). If the identity of the reviewer is not known, the method 700 may proceed with operation 718; otherwise, during operation 714, a determination is made as to whether the reviewer is known to be a user of the item. For example, a purchase history of the reviewer may be accessed to determine if the reviewer has purchased the item.

A test is then performed to determine if the reviewer was determined to be a user of the item (operation 716). If the reviewer is known to not be a user of the item, the review may not be rated and the method 700 may proceed with operation 770 (FIG. 7D); otherwise, the method 700 may proceed with operation 718. In one example embodiment, if the reviewer is not known to have purchased the item, the review may not be rated and the method 700 may proceed with operation 770; otherwise, the method 700 may proceed with operation 718.

A test is performed to determine if the reviewer has a known rating (operation 718). For example, a table of known reviewers may be maintained and the table may be accessed to determine if the reviewer is rated. the reviewer has a known rating, the method 700 may proceed with operation 722; otherwise, an attempt is made to rate the reviewer (operation 720). For example, a count of reviews submitted by a user may be determined, and the reviewer's rating may be determined based on the count of submitted reviews where a higher count indicates a higher rating. In one example embodiment, statistical analysis may be performed on the ratings specified in a review(s) by the reviewer to determine a rating of the reviewer. For example, a determination may be made of whether the reviews submitted by the reviewer have an excessive percentage of high and/or low reviews and/or a suspicious distribution of reviews (e.g., 50% of the reviews are rated one and 50% of the reviews are rated ten on a scale of one to ten). If the reviewer has, for example, an excessively high percentage of low reviews (such as 90%), the reviewer may be given a low rating (such as a two on a scale of one to ten).

The reviewer's rating may be compared to a reviewer threshold (operation 722). For example, the reviewer's rating may be compared to a reviewer threshold of seven (on a scale of one to ten). A test is then performed to determine if the reviewer's rating is less than the reviewer threshold (operation 724). If the reviewer's rating is less than the reviewer threshold, the review is not rated and the method 700 proceeds with operation 770; otherwise, the review may be weighted based on the reviewer's weighting (operation 726). For example, the confidence rating of the review may be increased or decreased in proportion to the reviewer's normalized rating, where the rating is normalized between zero and one based on the ratings of a plurality of reviewers. During operation 770, the review is marked as invalid or, optionally, as irrelevant and the method 700 proceeds with operation 766.

In one example embodiment, one or more characteristics of the user may be compared to one or more characteristics of the reviewer (operation 728). A characteristic of a user may be a list of friends of the user or reviewer, the style of reviews submitted by the user or reviewer, the hobbies or interests of the user or reviewer, the mindsets of the user and reviewer, and the like. For example, the hobbies of the reviewer and the user may be compared; if at least one of the hobbies of the reviewer and the user match, a synergy exists between the reviewer and the user.

A test is then performed to determine if at least one characteristic of the reviewer substantially matches at least one corresponding characteristic of the user (operation 730). If at least one characteristic of the reviewer substantially matches at least one characteristic of the user, the rating of the reviewer may be increased, the weighting of the review may be increased, and/or the confidence rating of the review may be increased (operation 732). For example, the weighting of the review may be increased, for example, by 20%. If none of the compared characteristics of the reviewer substantially matches the characteristics of the user, the rating of the reviewer may be decreased, the weighting of the review may be decreased, and/or the confidence rating of the review may be decreased (operation 734). The weighting of the review may be decreased, for example, by 20%.

A test is then performed to determine if the reviewer is a friend of the user (operation 736). If the reviewer is a friend of the user, the rating of the reviewer may be increased, the weighting of the review may be increased, and/or the confidence rating of the review may be increased (operation 738). For example, the weighting of the review may be increased, for example, by 60%. If the reviewer is not a friend of the user, the rating of the reviewer may he decreased, the weighting of the review may be decreased, and/or the confidence rating of the review may be decreased (operation 740). The weighting of the review may be decreased, for example, by 20%.

A test is then performed to determine if the reviewer is trusted (operation 742). For example, a test may be performed to determine if the reviewer is trusted by the user. If the reviewer is trusted, the rating of the reviewer may be increased, the weighting of the review may be increased, and/or the confidence rating of the review may be increased (operation 744). For example, the weighting of the review may be increased, for example, by 100%. If the reviewer is not trusted, the rating of the reviewer may be decreased, the weighting of the review may be decreased, and/or the confidence rating of the review may be decreased (operation 746). The weighting of the review may be decreased, for example, by 80%.

The review may be analyzed to determine if the review is marked or tagged (operation 748). For example, the review may be marked as being helpful or unhelpful to a reader. If the review is marked as helpful, the weight of the review may be increased (operation 750). For example, the weight of the review may be increased, for example, by 50%. If the review is marked as unhelpful, the weight of the review may be decreased (operation 752). For example, the weight of the review may be decreased, for example, by 50%.

In one example embodiment, natural language processing may be performed on the selected review (operation 754). For example, natural language processing may be performed to determine the subject of the review. A test is performed to determine if the item is the subject of the review (operation 756). If the item is not the subject of the review, the method 700 proceeds with operation 766 (FIG. 7D); otherwise, a test is performed to determine if the style of the review is authentic (operation 758). For example, a test is performed to determine if the review has proper grammar, if the review appears to be written by a user (as opposed to a computer), if the reviewer can be authenticated, and the like. If the review is not authentic, the method 700 proceeds with operation 766; otherwise, a test is performed to determine if the style of the review matches the style of one or more reviews that are known to be unreliable (operation 760). if the style of the review matches the style of one or more reviews that are known to be unreliable, the method 700 proceeds with operation 766; otherwise, a test is performed to determine if the style of the review matches the style of one or more reviewers that are known to be unreliable (operation 762). If the style of the review matches the style of one or more reviewers that are known to be unreliable, the method 700 proceeds with operation 766; otherwise, a weighted score for the review and, optionally, a confidence level for the review may be calculated (operation 764). For example, one or more scores indicated in the review may be weighted by the rating of the reviewer and/or the weight assigned to the review. The weighted score may then be combined with the weighted scores of other reviews to generate a combined score for the item.

In one example embodiment, the rating of the reviewer may be used to generate a weight for the reviewer, where a higher rating generates a higher weight. For example, the rating of the reviewer may be normalized to a scale of zero to one and the normalized value may be used as a weight. The weight assigned to the reviewer and/or the weight assigned to the review may be averaged to determine the weight assigned to the review for use in computing the overall score. In one example embodiment, the weight assigned to the reviewer is multiplied by the weight assigned to the review to determine the weight assigned to the review for use in computing the overall score.

In one example embodiment, a confidence level of the review may be based on the weight of the item review. For example, the confidence level may be set equal to the weight of the item review. In one example embodiment, the confidence level of the review is based on the number of weight increases and the number of weight decreases executed during the performance of the method 700, where each weight increase increases the confidence level and each weight decrease decreases the confidence level. For example, a review which has experienced four weight increases during the performance of the method 700 may be assigned a confidence level of one whereas a review which has experienced four weight decreases during the performance of the method 700 may be assigned a confidence level of zero.

A test may be performed to determine if all available reviews for the item have been processed (operation 766). If all reviews have not been processed, the method 700 may proceed with operation 704; otherwise, an overall weighted score for the item and, optionally, an overall confidence level for the item review(s) may be calculated (operation 768). In one example embodiment, the overall weighted score is a weighted average of a plurality of the item reviews. In one example embodiment, the overall confidence level of the review is based on an average of the confidence levels of the item reviews used in the calculation of the overall weighted score. In one example embodiment, the overall confidence level of the review is based on a weighted average of the confidence levels of the item reviews used in the calculation of the overall weighted score, where each weight is the weight of the corresponding item review. The method 700 may then end.

In one example embodiment, the method 700 proceeds to operation 770 from operation 756 if the item is not the subject of the review. In one example embodiment, the method 700 proceeds to operation 770 from operation 758 if the review style is not authentic. In one example embodiment, the method 700 proceeds to operation 770 from operation 760 if the style of the review matches the style of an unreliable review(s). In one example embodiment, the method 700 proceeds to operation 770 from operation 762 if the style of the review matches the style of an unreliable reviewer(s).

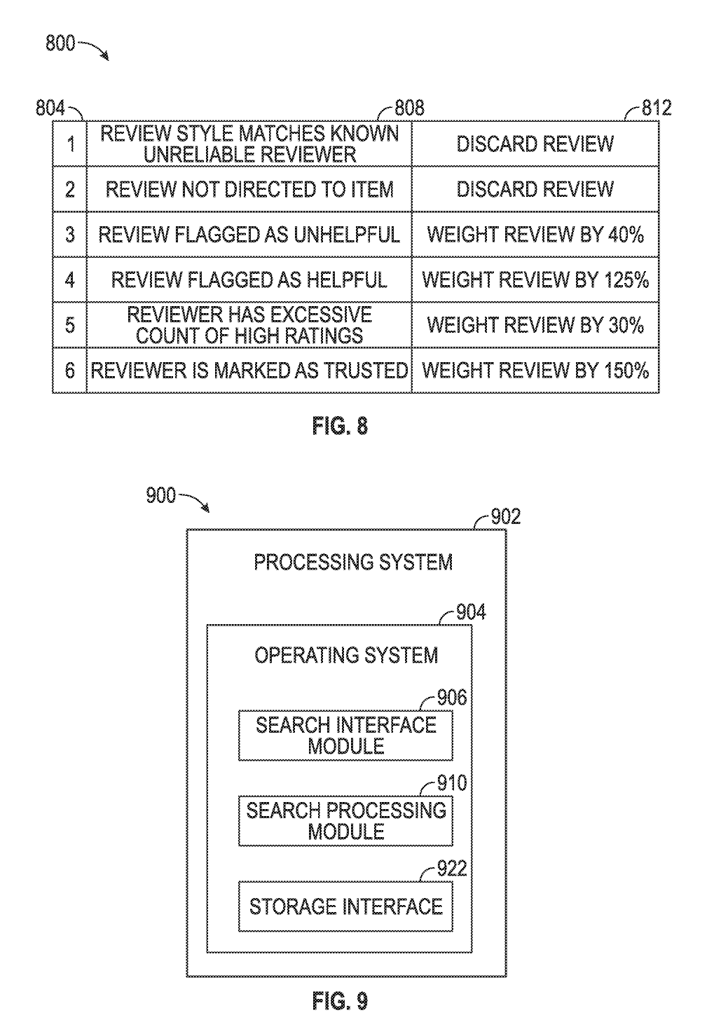

FIG. 8 is a table 800 of example rules for validating reviews of products and/or services, in accordance with an example embodiment. The table 800 may comprise one or more rows, where each row represents a rule. Each rule may comprise a rule identifier 804, a review condition 808, and an action 812.

For example, rule 1 has a condition of “review style matches known unreliable reviewer.” According to rule 1, if the review style matches a known unreliable reviewer, the review is discarded. For example, rule 2 has a condition of “review not directed to item.” According to rule 2, if the review is not directed to the item, the review is discarded. For example, rule 3 has a condition of “review flagged as unhelpful.” According to rule 3, if the review is flagged as unhelpful, the weight of the review is set to 40%. In one example embodiment, table 800 is used by method 700 to determine a weight for a review. For example, during operation 750 (FIG. 7C), rule 4 may be used to deter nine the weight for the corresponding review. In one example embodiment, each rule of table 800 may be processed during the execution of method 700; if the condition of the rule is determined to be true, then the review is weighted as indicated by the corresponding rule.

FIG. 9 is a block diagram of an example apparatus 900 for performing a search for products and/or services, in accordance with an example embodiment. The apparatus 900 is shown to include a processing system 902 that may be implemented on a client or other processing device that includes an operating system 904 for executing software instructions. In accordance with an example embodiment, the apparatus 900 may include a search interface module 906 and a search processing module 910. In accordance with an example embodiment, the apparatus 900 may further include a storage interface 922 In one example embodiment, the apparatus 900 may be a component of the item listing and identification processing system 130.

The search interface module 906 may obtain search terms and consumer filter selections from the user device 104-1; may provide a search result list to the user device 104-1; and may obtain consumer item selections from the user device 104-1. The search processing module 910 may conduct a search for items in a known manner based on the search terms and consumer filter selections from the user device 104-1, and may generate the search result list for the user device 104-1. The storage interface 922 may provide access to databases containing item listings. For example, the storage interface 922 may provide access to storage listings within seller processing systems 108.

Although certain examples are shown and described here, other variations exist and are within the scope of the invention. will be appreciated, by those of ordinary skill in the art, that any arrangement, which is designed or arranged to achieve the same purpose, may be substituted for the specific embodiments shown. This application is intended to cover any adaptations or variations of the example embodiments of the invention described herein. It is intended that this invention be limited only by the claims, and the full scope of equivalents thereof.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connects the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules, The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via the network 115 (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by the network 115.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through the network 115. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

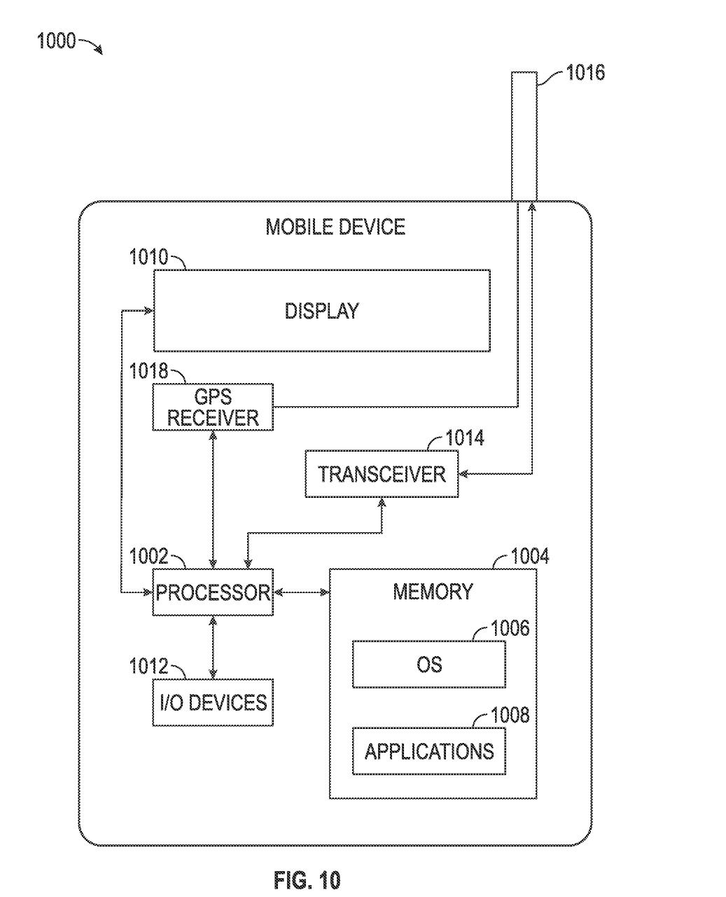

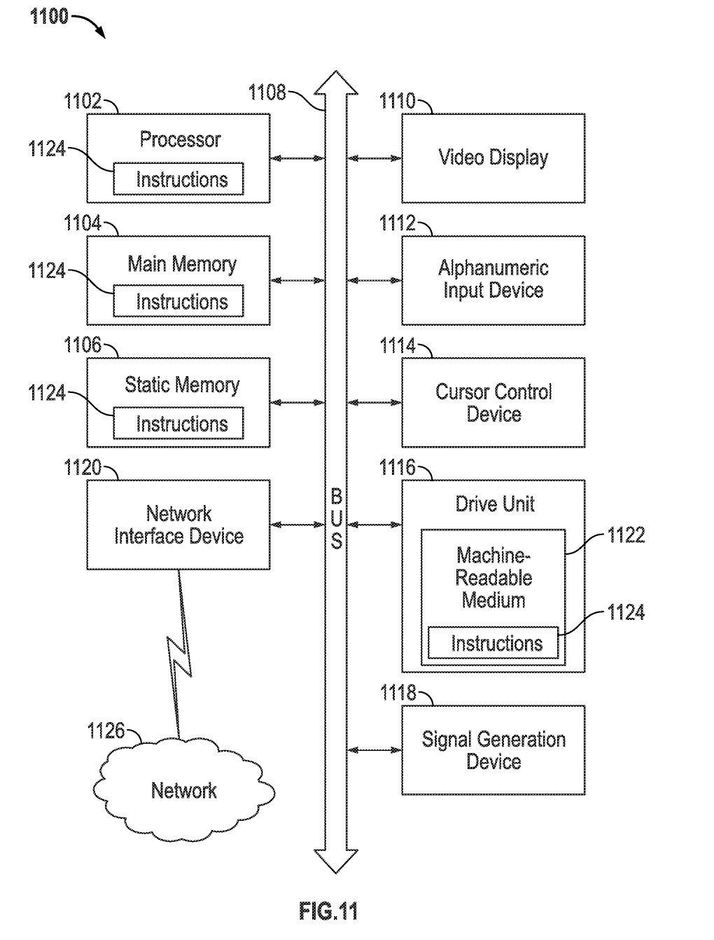

FIG. 10 is a block diagram illustrating a mobile device 1000, according to an example embodiment. The mobile device 1000 can include a processor 1002. The processor 1002 can be any of a variety of different types of commercially available processors suitable for mobile devices 1000 (for example, an XScale architecture microprocessor, a Microprocessor without interlocked Pipeline Stages (MIPS) architecture processor, or another type of processor). A memory 1004, such as a random access memory (RAM), a Flash memory, or other type of memory, is typically accessible to the processor 1002. The memory 1004 can be adapted to store an operating system (OS) 1006, as well as applications 1008, such as a mobile location-enabled application that can provide location based services (LBSs) to a user. The processor 1002 can be coupled, either directly or via appropriate intermediary hardware, to a display 1010 and to one or more input/output (I/O) devices 1012, such as a keypad, a touch panel sensor, and a microphone. Similarly, in some embodiments, the processor 1002 can be coupled to a transceiver 1014 that interfaces with an antenna 1016. The transceiver 1014 can be configured to both transmit and receive cellular network signals, wireless data signals, or other types of signals via the antenna 1016, depending on the nature of the mobile device 1000. Further, in some configurations, a GPS receiver 1018 can also make use of the antenna 1016 to receive GPS signals.

FIG. 11 is a block diagram of a machine within which instructions may be executed for causing the machine to perform any one or more of the methodologies discussed herein. In one example embodiment, the machine may be the example apparatus 300 of FIG. 3 for processing reviews and/or the example apparatus 900 of FIG. 9 for performing a search for products and/or services. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein,

The example computer system 1100 includes a processor 1102 (e.g., a central processing unit (CPU), a graphics processing unit (GPU) or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a cursor control device 1114 (e.g., a mouse), a disk drive unit 1116, a signal generation device 1118 (e.g., a speaker) and a network interface device 1120.

### Machine-Readable Medium

The drive unit 1116 includes a machine-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104 and/or within the processor 1102 during execution thereof by the computer system 1100, the main memory 1104 and the processor 1102 also constituting machine-readable media. Instructions 1124 may also reside within the static memory 1106.

While the machine-readable medium 1122 is shown in an example embodiment to be a single medium, the term “machine-readable medium” may include a single medium or multiple media (e.g., a centralized or distributed database, and/or associated caches and servers) that store the one or more data structures or instructions 1124. The term “machine-readable medium” shall also be taken to include any tangible medium that is capable of storing, encoding or carrying instructions 1124 for execution by the machine and that cause the machine to perform any one or more of the methodologies of the present invention, or that is capable of storing, encoding or carrying data structures utilized by or associated with such instructions 1124. The term “machine-readable medium” shall accordingly be taken to include, but not be limited to, solid-state memories, and optical and magnetic media. Specific examples of machine-readable media 1122 include non-volatile memory; including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks. Machine readable medium specifically excludes signals per se.

### Transmission Medium

The instructions 1124 may further be transmitted or received over a communications network. 1126 using a transmission medium. The instructions 1124 may be transmitted using the network interface device 1120 and any one of a number of well-known transfer protocols (e.g., Hypertext Transfer Protocol (HEW)). Examples of communication networks 1126 include a local area network (“LAN”), a wide area network (“WAN”), the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions 1124 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system for processing item reviews, the system comprising a review processing module comprising one or more hardware processors, the review processing module configured to:
obtain a review for an item;
analyze content of the item review and a reviewer of the item; and
determine a review weighting based on the analysis of the content of the item review and the reviewer of the item.

2. The system of claim 1, wherein the review processing module is further configured to correlate the item review to the reviewer.

3. The system of claim 1, wherein the review processing module is further configured to:
determine if the reviewer is known to have purchased the item; and
discard the item review if the reviewer is not known to have purchased the item.

4. The system of claim 1, wherein the review processing module is further configured to discard the item review if a rating of the reviewer is less than a threshold rating.

5. The system of claim 1, wherein the review processing module is further configured to weight the item review based on a synergy between the reviewer and a user of the item review.

6. The system of claim 1, wherein the review processing module is further configured to weight the item review based on the reviewer being a friend of a user of the item review.

7. The system of claim 1, wherein the review processing module is further configured to weight the item review based on the reviewer being a trusted reviewer.

8. The system of claim 1, wherein the review processing module is further configured to weight the item review based on the item review being marked as helpful or unhelpful.

9. The system of claim 1, wherein the review processing module is further configured to perform natural language processing on content of the item review to determine one or more of: whether the item is a subject of the item review, whether a style of the item review is authentic, whether the style of the item review matches a style of an unreliable item review, and whether the style of the item review matches a style of an unreliable reviewer.

10. The system of claim 9, wherein the review processing module is further configured to:
discard the item review if the item is not the subject of the item review, the style of the item review is not authentic, the style of the item review matches the style of the unreliable item review, or the style of the item review matches the style of the unreliable reviewer; and
score the item review if the item is the subject of the item review, the style of the item review is authentic, the style of the item review does not match the style of the unreliable item review, and the style of the item review does not match the style of the unreliable reviewer.

11. The system of claim 1, wherein the review processing module is further configured to compute an overall score for the item review and an overall confidence level for the item review.

12. A method for processing item reviews, the method comprising:
obtaining a review for an item;
analyzing content of the item review and a reviewer of the item; and
determining a review weighting based on the analysis of the content of the item review and the reviewer of the item,

13. The method of claim 12, further comprising correlating the item review to the reviewer.

14. The method of claim 12, further comprising:
determining if the reviewer is known to have purchased the item; and
discarding the item review if the reviewer is not known to have purchased the item.

15. The method of claim 12, further comprising discarding the item review if a rating of the reviewer is less than a threshold rating.

16. The method of claim 12, further comprising weighting the item review based on a synergy between the reviewer and a user of the item review.

17. The method of claim 12, further comprising weighting e item review based on the reviewer being a friend of a user of the item review.

18. The method of claim 12, further comprising weighting the item review based on the reviewer being a trusted reviewer.

19. The method of claim 12, further comprising weighting the item review based on the item review being marked as helpful or unhelpful.

20. A non-transitory computer-readable medium embodying instructions that, when executed by a processor, perform operations comprising:
obtaining a review for an item;
analyzing content of the item review and a reviewer of the item; and
determining a review weighting based on the analysis of the content of the item review and the reviewer of the item.
